(19) United States
(12) Patent Application Publication
(10) Pub. No.: US 2006/0058137 A1
(43) Pub. Date: Mar. 16, 2006

(54) Ring saw drive device and cutter device with ring saw

(76) Inventor: Kazumasa Matsuura, Hiroshima (JP)

Correspondence Address: WENDEROTH, LIND & PONACK, L.L.P., 2033 K STREET N. W., SUITE 800, WASHINGTON, DC, 20006-1021, US

(21) Appl. No.: 10/521,574

(22) PCT Filed: Jul. 16, 2003
(86) PCT No.: PCT/JP03/09053

§ 371 Date: Jan. 18, 2005

(30) Foreign Application Priority Data
Jul. 18, 2002 (JP) 2002-209494
May 7, 2003 (JP) 2003-129359

(51) Int. Cl. F16H 7/00; F16H 7/12

(52) U.S. Cl. 474/139; 474/136

(57) ABSTRACT

This is related to a driver for driving into circulation a ring saw having a cutting edges in an outer periphery thereof, and to a cutter device having the ring saw to be fixed as an attachment to an arm tip of a shovel-based excavator. An endless strip (6), (46), (51) for circulatively driving the ring saw main body (5), (13), (39) is arranged in a manner being wound at a part of an outer periphery thereof over a part of an outer periphery of the ring saw main body (5), (13), (39). Namely, the ring saw main body (5), (13), (39) is to be driven by an endless strip (6), (46), (51). Moreover, by directly driving the ring saw main body (5), (13), (39) on an outer peripheral side of the endless strip (6), (46), (51) peripheral circuit, the ring saw main body (5), (13), (39) can be inserted deep in a subject-of-cut (32) despite using the endless strip (6), (46), (51). Power is conveyed through a contact of the endless strip (6), (46), (51) and the ring saw main body (5), (13), (39) over a broad range, thereby reducing friction in the power transmission and enabling efficient power conveyance from the endless strip (6), (46), (51) to the ring saw main body (5), (13), (39).

### TECHNICAL FIELD

This invention relates to a driver for driving into circulation a ring saw as an annular saw blade having cutting edges in an outer periphery thereof, and to a ring-saw-equipped cutter device to be removably fixed as an attachment to an arm tip of a shovel-based excavator such as a backhoe.

### BACKGROUND ART

The ring-saw-equipped cutter device, for sawing a subject-of-cut by driving into circulation a ring saw, has a feature of extremely low frictional loss in cutting and hence well cut efficiency. The drivers for driving into circulation the ring saw are generally structured that inner teeth are formed in the inner peripheral surface of a ring saw main body so that the ring saw main body can be driven into circulation by a driving gear in mesh with the inner teeth, as disclosed in JP-UM-A-49-3195 (Japanese Utility Model Laid-open Number 1974-3195), for example. In this case, in order to efficiently convey the power of the driver to the ring saw main body by positively engaging the driving gear with the inner teeth of the ring saw main body, a guide roller is provided on an outer peripheral side of the ring saw main body. By the guide roller and the driving gear, the ring saw main body is supported by being clamped at the inside and outside thereof.

Besides such drivers of the inner teeth type, there is generally known an outer teeth type driver which has a ring saw main body formed with an outer teeth in the outer peripheral surface thereof so that the ring saw main body can be driven into circulation by the driving gear in mesh with the outer teeth, as disclosed in JP-UM-A-52-82286 (Japanese Utility Model Laid-open Number 1977-82286), for example.

However, both the drivers of the inner and outer teeth types are structured with a point or line contact at one tooth-to-tooth point in its power transmission, thus having a setback of increased on-surface pressure at the contact between the teeth. Thus, there is a disadvantage that friction is great at the power transmission and power could not be conveyed with efficiency.

Meanwhile, there is also a defect that, in case a great cut resistance instantaneously occurs during sawing by means of the cutter device fixed at an arm tip of a shovel-based excavator such as a backhoe, there is nothing to absorb such a force and hence the ring saw main body readily stops from circulation.

In addition, with the structure for driving the ring saw main body by the driving gear, there is a trouble that a foreign matter is caught between the ring saw main body and the driving gear resulting in stoppage from circulation of the ring saw main body. Particularly, where the cutter device is mounted on a backhoe and used in application of sawing a stone or concrete structure, the ring saw main body is readily stopped because of catching hard foreign matters of sand, pebble, etc.

Therefore, it is an object of the invention to eliminate the foregoing disadvantage and to provide a ring saw driver which is low in friction and excellent in transmission efficiency at the power transmission wherein the ring saw is not readily stopped due to the occurrence of a great cut resistance or catching of foreign matters during cutting, and a ring-saw-equipped cutter device having such a driver and to be removably fixed as an attachment to a shovel-based excavator.

### DISCLOSURE OF THE INVENTION

In order to solve the above problem, a ring saw driver of the invention comprises: a ring saw main body having a multiplicity of cutting edges along an outer periphery thereof; and an endless strip arranged in a manner being wound at a part of an outer periphery thereof over a part of an outer periphery of the ring saw main body, and for driving the ring saw main body into circulation. Namely, the ring saw main body is to be driven by an endless strip. Moreover, by directly driving the ring saw main body on an outer peripheral side of the endless strip peripheral circuit, the ring saw main body can be inserted deep in a subject-of-cut despite using the endless strip. In this manner, driving is effected by means of a part of the outer periphery of the endless strip wound over the outer periphery of the ring saw main body. Power is conveyed through a contact of the endless strip and the ring saw main body over a broad range, thus reducing the on-surface pressure at the power transmission. Accordingly, friction can be reduced in the power transmission, enabling efficient power conveyance from the endless strip to the ring saw main body.

Meanwhile, on the endless strip curved in a state wound over the ring saw main body, a force to assume linear always acts in circulation during cutting. By the action of the force, the ring saw main body can be held in a manner not departing from a subject-of-cut. When a great cut resistance instantaneously acts during cutting, the endless strip retracts to obtain such an action as a cushion to absorb the force. Accordingly, when fixed to a machine of a backhoe or the like, sawing operation can be effected continuously without stopping the circulation of the ring saw main body.

Meanwhile, by using an endless belt as the endless strip, noise can be reduced as compared to the case with a chain during cutting. Furthermore, because the endless belt is light in weight as compared to the chain, speed can be increased. Accordingly, the time required in sawing can be shortened, contributing to the improvement in operation efficiency. Furthermore, by such speed increase, the torque required in cutting can be obtained even if the ring saw main body is reduced in its circulation radius. Application is suitable for a handy-type cutter device requiring light-weight and small size. In addition, maintenance is by far easy as compared to that with the chain.

Furthermore, by providing the endless belt with such a recess or a projection as to engage with a projection or a recess in the outer periphery of the ring saw main body, engagement can be positive over a broad range. Accordingly, the endless strip is not easily disengaged during driving of the ring saw main body into circulation.

Furthermore, by providing the endless belt with a through-hole for avoiding an interference of the ring saw main body with the cutting edge, the cutting edge at its tip is not to hit an outer peripheral surface of the endless belt, thus preventing the endless belt from being deformed or damaged. Meanwhile, even when a foreign matter is caught between the endless belt and the ring saw main body, the foreign matter can be removed upward out of the through-hole of the endless belt without stopping the circulation of the ring saw main body.

Meanwhile, by using an endless chain as the endless strip, even in case a foreign matter is caught between the endless chain and the ring saw main body, the foreign matter is removed from a roller-to-roller gap of the endless chain, thus preventing the ring saw main body from being stopped from circulation.

The endless strip is wound over a plurality of rotary members, part of the rotary members being a driving sprocket or pulley operably coupled to a prime mover of a hydraulic motor or the like.

In a certain case, the endless strip is wound over two rotary members, at least one of the rotary members being a driving sprocket or pulley. Due to this, the driver can be reduced in the number of members, and the driver can be reduced in weight and made compact.

One or a plurality of inner support members supporting the ring saw main body at an inside thereof are provided on an inner peripheral side of the ring saw main body.

Meanwhile, by making part of or all the rotary members to be changed in position along a plane including a circulation plane of the endless strip, the endless strip can be adjusted in tension to a diameter of the ring saw main body so that the endless strip can be wound over along the outer periphery of the ring saw main body by changing a position of the rotary member without causing a gap.

Furthermore, the ring saw main body is removably attached on the driver, part of or all the inner support members being to be changed in position along a circulation plane direction of the ring saw main body, a ring saw main body different in diameter being to be attached by changing a position of the inner support member or by changing a position of the inner support member and the rotary member. Due to this, the inner support member can be moved to a position suited for the diameter of the ring saw main body. The ring saw main body can be attached in a stable state.

Furthermore, by arranging a pair of side-surface support members in a manner clamping the ring saw main body at both side surface thereof, the ring saw main body can be driven to circulate in a stable state that lateral vibration is suppressed. Further, the ring saw main body can be prevented from disengaging from the endless strip or inner support member due to an impact, etc. caused upon putting the ring saw main body onto a subject-of-cut.

More specifically, the side-surface support member is a guide roller to roll-contact with a side surface of the ring saw main body due to circulation of the ring saw main body.

Meanwhile, in order to solve the foregoing problem, a ring saw-equipped cutter device of the invention is to be removably fixed as an attachment to an arm tip of a shovel-based excavator such as a backhoe, the cutter device comprising: a ring saw main body having a multiplicity of cutting edges along an outer periphery thereof; and an endless strip arranged in a manner being wound at a part of an outer periphery thereof over a part of an outer periphery of the ring saw main body and for driving the ring saw main body into circulation. Due to this, it can be used on the existing shovel-based excavator, thus being highly versatile. Meanwhile, it is economical because of no need of purchasing a large-scaled, exclusive cutter device for sawing a stone.

### BRIEF DESCRIPTION OF THE DRAWINGS

FIG. 1 is a view showing a ring saw driver according to a first embodiment of the invention.

FIG. 2 is a magnified view showing a connection of a ring saw main body and an endless belt.

FIG. 3 is a perspective view showing a use state of a ring saw-equipped cutter device.

FIG. 4 is a view showing a driver attached with a ring saw main body smaller in diameter.

FIG. 5 is a view showing a state attached with a lateral-vibration-preventing guide roller.

FIG. 6 is a view showing a ring saw driver according to a second embodiment of the invention.

FIG. 7 is a magnified view showing a connection of a ring saw main body and an endless belt of the same.

FIG. 8 is a view showing a driver attached with a ring saw main body smaller in diameter of the same.

FIG. 9 is a view showing a state attached with a lateral-vibration-preventing guide roller of the same.

FIG. 10 is a view showing a ring saw driver according to a third embodiment of the invention.

### BEST MODE FOR CARRYING OUT THE INVENTION

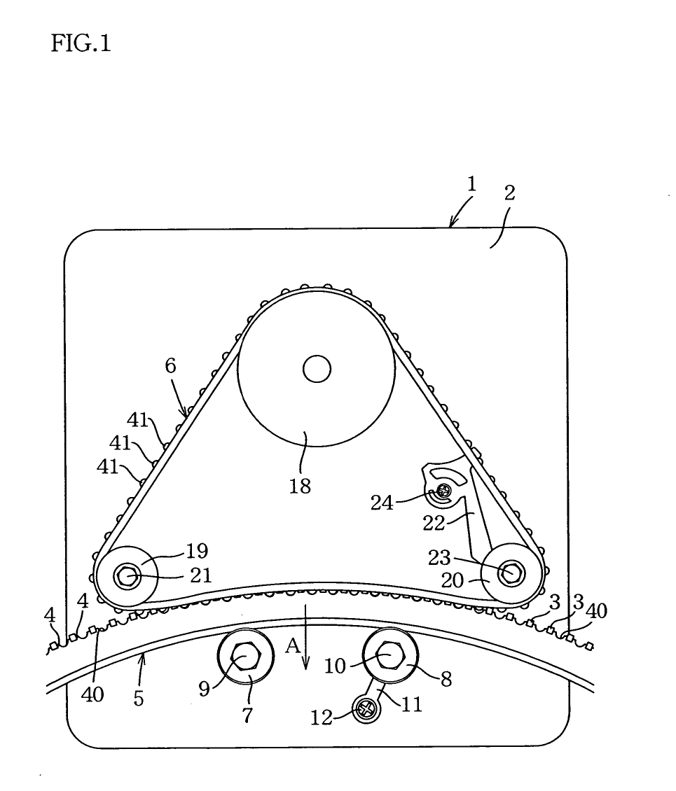

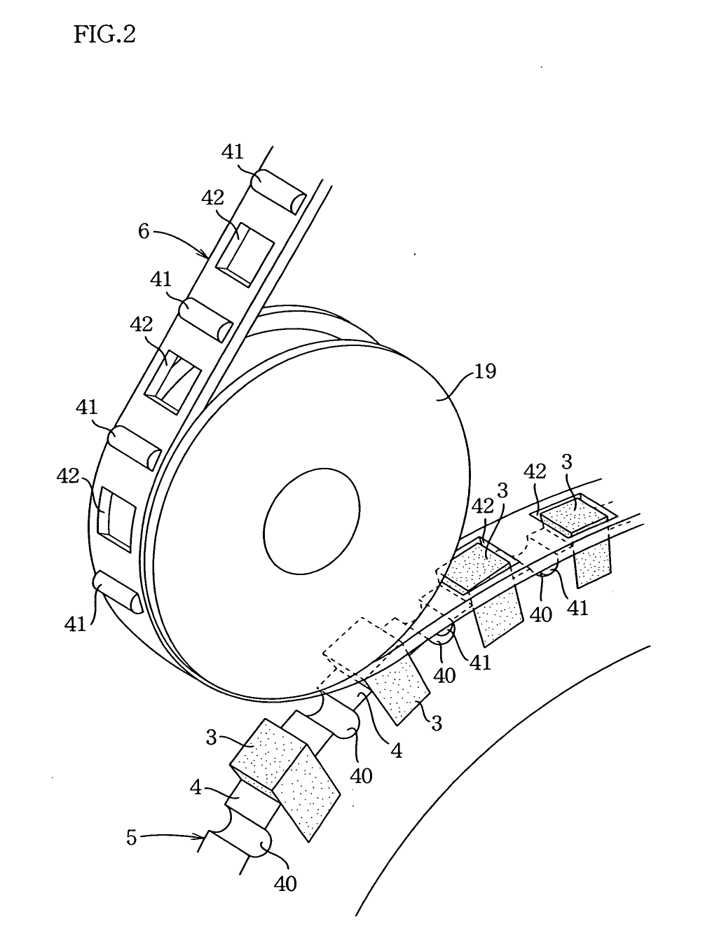

Hereunder, embodiments of the invention will be explained based on the drawings. A ring saw driver in a first embodiment of the invention is to be attached to a side surface (2) of a case (1) of a ring-saw-equipped cutter device as shown in FIGS. 1 and 2, which comprises an annular ring saw main body (5) formed with a multiplicity of teeth (4), (4) having cutting edges (3), (3) along an outer periphery thereof, and an endless belt (6) for driving to circulate the ring saw main body (5).

The ring saw main body (5) is removably attached on the case (1) such that it is supported by a pair of inner guide rollers (7), (8) as inner support members arranged on an inner periphery thereof. More specifically, the ring saw main body (5) is supported on the inner guide rollers (7), (8) in a state the ring saw main body (5) at its inner periphery upper end is abutted against the outer periphery upper end of the inner guide rollers (7), (8) attached on the side surface (2) of the case (1).

The cutting edges (3), (3) . . . are formed, for example, of diamond chips and removably attached at tips of the teeth (4), (4). Accordingly, when worsened in cutting quality, the cutting quality can be reproduced by merely replacing the cutting edges (3), (3), thus being economical. Incidentally, the cutting edges (3), (3) are not limited to diamond chips but may be removable metal or ceramic edges. Meanwhile, the cutting edge (3), (3) . . . may be in an edge-like form formed at the tip of the tooth (4), (4) . . . .

The inner guide rollers (7), (8) are rotatably supported by bolts (9), (10) arranged vertical to the side surface (2) of the case (1). Consequently, the ring saw main body (5) supported by the inner guide rollers (7), (8) is to be driven to circulate along the side surface (2) of the case (1) Incidentally, because the inner guide rollers (7), (8) are free to rotate, the ring saw main body (5) can be circulated smoothly.

The inner guide rollers (7), (8) comprise two kinds as a fixed inner guide roller (7) not to be changed in position and a movable inner guide roller (8) to be changed in position. The bolt (9) holding the fixed inner guide roller (7) at its axis is screwed to the side surface (2) of the case (1).

The bolt (10) holding the movable inner guide roller (8) at its axis is screwed to a vicinity of one end of an arm member (11) attached on the side surface (2) of the case (1). The arm member (11) has the other end rotatably screwed by a screw (12) to the side surface (2) of the case (1). By loosening the screw (12), the movable inner guide roller (8) can be swung, together with the arm member (11), along the side surface (2) of the case (1), i.e. along a circulation plane direction of the ring saw main body (5). Meanwhile, in case the screw (12) is tightened after positioning the movable inner guide roller (8) in position, the movable inner guide roller (8) can be fixed in an objective position.

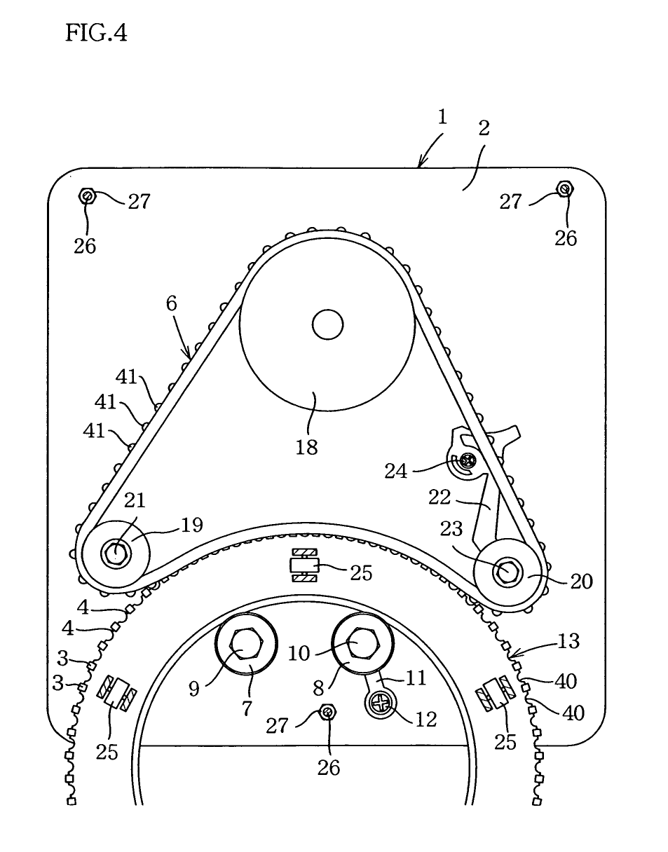

In this manner, because the movable inner guide roller (8) can be desirably changed in position along the circulation plane direction of the ring saw main body (5), the distance can be appropriately adjusted between the movable inner guide roller (8) and the fixed inner guide roller (7), making it possible to attach a ring saw main body (5) in various diameters in a stable state. For example, in the case that replacement is to a smaller diameter of ring saw main body (13) as shown in FIG. 4, the ring saw main body (13) can be attached by narrowing the distance between the movable inner guide roller (8) and the fixed inner guide roller (7).

Incidentally, the structure for changing the position of the movable inner guide roller (8) is not limited to that using the arm member (11). For example, a plurality of not-shown bolt holes may be previously provided in a predetermined position in the side surface (2) of the case (1) so that the bolt (10) for supporting the movable inner guide roller (8) can be screwed to the case (1) by use of any of the bolt holes depending upon the situation. Besides, it can be considered to provide an elliptic bolt hole in a predetermined position of side surface (2) of the case (1) so that the movable inner guide roller (8) can be attached to the side surface (2) of the case (1) by use of a bolt movable along the elliptic bolt hole. Furthermore, the movable inner guide roller (8) is not limited to one in the number, e.g. all the inner guide rollers may be provided as movable inner guide rollers.

The endless belt (6), although considered formed of rubber or other resin, steel or a composite material in a combination thereof, may be of another material than those.

Meanwhile, the endless belt (6) is arranged such that part of its outer periphery is wound over a part of the outer periphery of the ring saw main body (5) as shown in FIG. 1. Namely, the endless belt (6) is curved in a state wound over the ring saw main body (5). However, in circumferential movement during cutting, a force to assume linear is always to act in a direction of the arrow A in the figure. By the action of the force, the ring saw main body is supported not to depart from a subject-of-cut. When a great cut resistance acts instantaneously during cutting, the endless belt (6) retracts reverse to the direction of arrow A in the figure thus obtaining such an action as a cushion to absorb the force. Accordingly, when mounted on such a machine as a backhoe, continuous cutting operation is possible without stopping the circulation of the ring saw main body.

The endless belt (6) has, in its outer peripheral surface, a plurality of projections (41), (41) . . . at a constant interval in a lengthwise direction thereof. Meanwhile, ring saw main body (5) has, in its outer peripheral surface, recesses (40), (40) . . . between mutually adjacent ones of the teeth (4), (4). In the portion of the endless belt (6) wound over the ring saw main body (5), engagement is made between the projection (41), (41) . . . of the endless belt (6) and the recess (40), (40) . . . of the ring saw main body (5). The projections (41) are provided in a manner extending along a widthwise direction of the belt, whose sectional form is given nearly semi-circular.

Meanwhile, the endless belt (6) is provided with through-holes (42), (42) for avoiding the interference between the portion thereof wound over the ring saw main body (5) and the cutting edge (3), (3) of the ring saw main body (5). Each through-hole (42) is formed rectangular as viewed at the surface of the belt. Namely, the through-hole (42), (42) . . . is to receive a tip of the cutting edge (3), (3) of the ring saw main body (5). Consequently, because there is no possibility that the cutting edge (3), (3) at its tip hits the outer peripheral surface of the endless belt (6), the endless belt (6) can be prevented from being deformed or damaged.

When the endless belt (6) is moved circumferentially, the projection (41), (41) of the endless belt (6) pushes the recess (40), (40) . . . of the ring saw main body (5) in mesh with the projection (41), (41) into movement, thus circulating the ring saw main body (5). In this manner, power is transmitted through a contact between the endless belt (6) and the ring saw main body (5) over a broad range.

Incidentally, the engagement between the outer periphery of the endless belt (6) and the outer periphery of the ring saw main body (5) is not limited to the above structure. For example, it can be considered that recesses are provided in the outer peripheral surface of the endless belt (6) so that engagement can be made between the recess of the endless belt (6) and the tooth (4), (4) as a projection on the ring saw main body (5). The power transmission of from the endless belt (6) to the ring saw main body (5) is not limited to such an engagement structure but may be a friction-based structure if available.

In this manner, the ring saw main body (5) is caused to circulate by the endless belt (6). Even when a foreign matter is caught between the ring saw main body (5) and the endless belt (6) during cutting operation, the foreign matter is removed upward out of the through-hole (42), (42). Hence the ring saw main body (5) is not stopped from circulating.

Furthermore, the endless belt (6) is arranged on the outer peripheral side of the ring saw main body (5). There is no need to arrange an endless belt (6), a pulley (18), (19), (20), a sprocket or the like for circumferentially moving the endless belt (6), in the space inner than the inner peripheral surface of the ring saw main body (5). Thus, there is no possibility that, when inserting the ring saw main body (5) in a subject-of-cut, such a pulley (18), (19), (20) or the like interferes obstructively with the subject-of-cut. Accordingly, the ring saw main body (5) can be inserted deep in the subject-of-cut.

The endless belt (6) is attached on the side surface (2) of the case (1) above the ring saw main body (5), and wound over the three pulleys (18), (19), (20) arranged in a manner assuming triangular apexes. Incidentally, rotary members such as sprockets may be used in place of the pulleys (18), (19), (20).

The three pulleys (18), (19), (20) include the pulley (18) positioned uppermost that is for driving and operably coupled to a hydraulic motor as a not-shown prime mover stored within the case (1). The endless belt (6) is moved circumferentially by the driving pulley (18), to drive the ring saw main body (5) into circulation. Accordingly, when the driving pulley (18) is rotatively driven by the hydraulic motor, the endless belt (6) circulates along the side surface (2) of the case (1), to circulatively drive the ring saw main body (5) operably associated with the endless belt (6).

Incidentally, the rotary members of pulleys, etc. over which the endless belt (6) is wound are not limited three in the number but may be two or four or more. Meanwhile, the prime mover is not limited to the hydraulic motor but may be an electric motor, for example.

The pulleys include a fixed pulley (19) and a movable pulley (20), besides the driving pulley (18). The three pulleys (18), (19), (20) are arranged in a state forming a triangle having the driving pulley (18) as an apex.

Meanwhile, the endless belt (6) pushes from above the ring saw main body (5). Accordingly, even when the ring saw main body (5) is urged on a subject-of-cut during cutting operation, the ring saw main body (5) is not readily lifted up. Thus, there is less possibility of displacement of the ring saw main body (5) from the guide rollers (7), (8).

The fixed pulley (19) is rotatably supported at its axis by a bolt (21) vertically screwed to the side surface (2) of the case (1).

The movable pulley (20) is rotatably attached by a bolt (23) to a vicinity of one end of a support member (22) attached to the side surface (2) of the case (1). This support member (22) has the other end rotatably supported at its axis by a screw (24) to the side surface (2) of the case (1). By loosening the screw (24), the movable pulley (20) can be swung, together with its support member (22), about the screw (24) along the side surface (2) of the case (1), i.e. along the plane including the endless belt (6). By tightening the screw (24), the support member (22) can be fixed on the case (1) and hence the movable pulley (20) can be fixed in position.

Because of the capability of changing the position of the movable pulley (20), tension can be adjusted over the endless belt (6). Accordingly, in the case of replacement to the smaller diameter of a ring saw main body (13) as shown in FIG. 4 for example, the tension over the endless belt (6) can be adjusted so that the endless belt (6) can be wound along an outer periphery of the ring saw main body (13) without causing a gap.

Incidentally, the structure for changing the position of the movable pulley (20) is not limited to that using the support member (22). For example, it can be considered to provide an elliptic bolt hole in a predetermined position of the side surface (2) of the case (1) and to attach the movable pulley (20) to the side surface (2) of the case (1) by use of a bolt movable along the elliptic bolt hole.

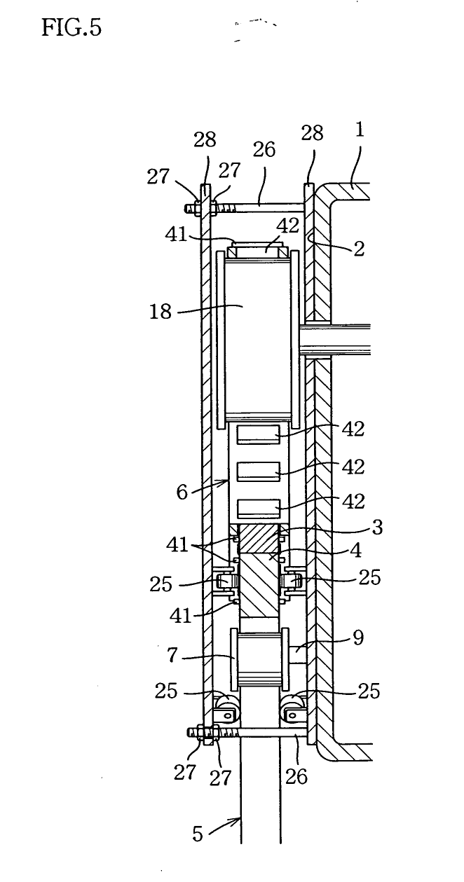

FIG. 5 shows a state of arranging a pair of side-surface guide roller (25), (25) as a side-surface support member for preventing the ring saw main body (5) from deviating vertically to the circulation plane thereof, on the both side surfaces of the ring saw main body (5).

On the side surface (2) of the case (1), a pair of plate members (28), (28) coupled together by bolts (26), (26) and nuts (27), (27) are provided in a manner clamping the ring saw main body (5) at both sides. On the opposite surfaces of the plate members (28), (28), side-surface guide rollers (25), (25) . . . are attached for rotation. More specifically, the side-surface guide rollers (25), (25) . . . are attached on the side surfaces of the ring saw main body (5) in a state being abutted against the side surfaces of the ring saw main body (5) in a manner movable along the ring saw main body (5) as shown in FIG. 4.

By attaching the side-surface guide roller (25), (25) in this manner, the ring saw main body (5) is to be prevented from deflecting in a horizontal direction and allowed to be driven for circulation in a stable state. Furthermore, the ring saw main body (5) is prevented from disengaging from the endless belt (8) or inner guide roller (7), (8) due to an impact the ring saw main body (5) is hit against a subject-of-cut.

Incidentally, the side-surface guide rollers (25), (25) . . . are not limited in the number, arrangement, attaching structure, etc. to the above but they are satisfactory provided that the ring saw main body (5) can be prevented from deviating vertically to the circulation plane.

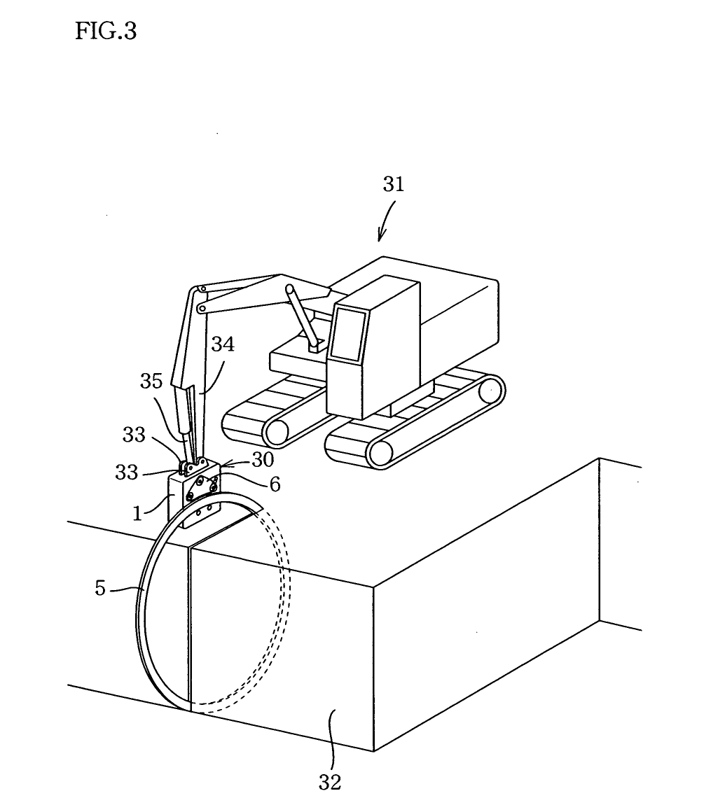

FIG. 3 shows a use state of a ring-saw-equipped cutter device (30) attached with the driver. The cutter device (30) is for sawing a subject-of-cut (32) such as a stone or concrete structure, by being fixed as an attachment to a shovel-based excavator (31) such as a backhoe. Incidentally, the subject-of-cut (32) is not limited to a structure of stone or concrete but may be of a wooden or metal material.

The cutter device (30) is provided with a pair of mount pieces (33), (33) on a top surface of the case (1). The mount piece (33), (33) is formed with not-shown mount holes in two positions, respectively. The cutter device (30) is attached to a tip of an arm (34) of a shovel-based excavator (31) by utilization of one mount holes, and to a tip of a working-tool cylinder head (35) by utilization of the other mount holes. In this manner, the cutter device (30) is highly versatile because it can be fixed as an attachment to the existing shovel-based excavator (31). Meanwhile, it is economical because of no need of purchasing a large-scaled, exclusive cutter device for sawing a stone.

Incidentally, the utilization form of the ring saw driver is not limited to the case of fixation to the attachment of the shovel-based excavator but can be considered utilized by being fixed to a handy-type cutter device.

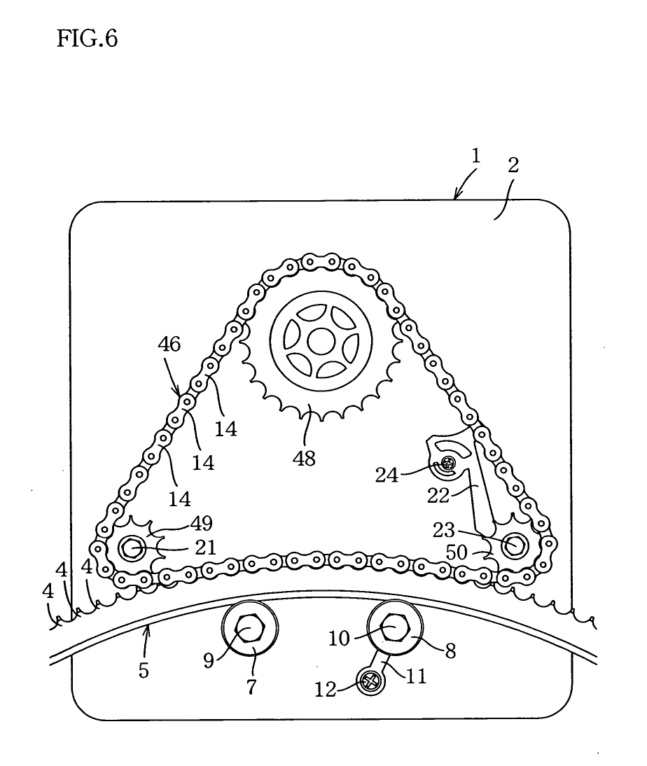

Now explanation is made on a ring saw driver according to a second embodiment of the invention, based on FIGS. 6 to 9. In this embodiment, an endless chain (46) is used as an endless strip for driving to circulate the ring saw main body (5).

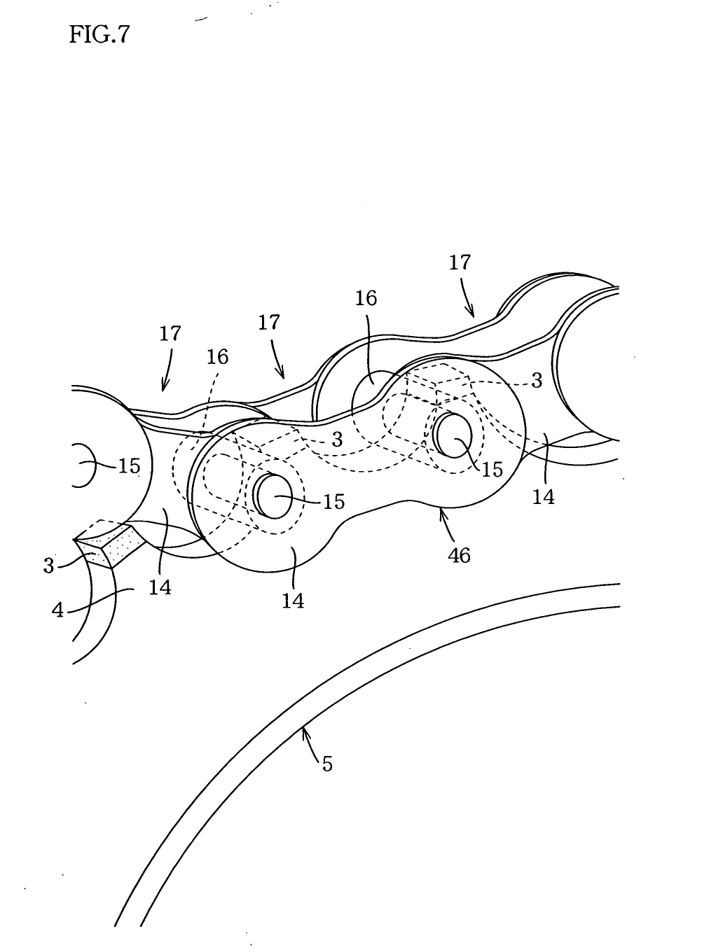

Concerning the endless chain (46), as shown in FIG. 7, engagement is made between the endless chain (46) and the teeth (4), (4) . . . of the ring saw main body (5) such that the teeth (4), (4) . . . of the ring saw main body (5) are to be engaged between bushes (16), (16) . . . externally fitted over pins (15), (15) . . . connecting between links (14), (14) . . . structuring the endless chain (46).

In the ring saw main body (5), when the endless chain (46) is circulated, the teeth (4), (4) . . . fit between the bushes (16), (16) are pushed into movement by the bushes (16), (16) of the endless chain (46). Namely, the ring saw main body (5) and the endless chain (46) are in an engagement relationship as if they were a sprocket and chain.

Because the ring saw main body (5) is circulated by the endless chain (46) in this manner, even when a foreign matter is caught between the ring saw main body (5) and the endless chain (46) during sawing operation, the foreign matter is removed out of the open region (17), (17) . . . in the above of between the bushes (16), (16). Thus, the ring saw main body (5) is not stopped from circulation.

Meanwhile, this embodiment uses sprockets (48), (49), (50) as rotary members for winding the endless chain (46). However, pulleys (18), (19), (20) similar to the first embodiment or other rotary members may be used in place of the sprockets (48), (49), (50).

The endless chain (46), wound over the sprockets (48), (49), (50), is put in engagement with the ring saw main body (5) at between the fixed sprocket (49) and the movable sprocket (50) positioned in a bottom of the triangle, in a state being pushed up by the upper end of the ring saw main body (5).

In this manner, because of engagement in a manner wound over a vicinity of the outer peripheral upper end of the ring saw main body (5) in a state curved upward along the outer periphery upper end of the ring saw main body (5), the engagement is with a greater number of teeth (4), (4) . . . than the case the endless chain (46) is merely stretched linearly. Power can be efficiently conveyed from the driving sprocket (48) to the ring saw main body (5).

Meanwhile, because the endless chain (46) and the ring saw main body (5) are in positive engagement over a broad range, the endless chain (46) is not readily disengaged during circulation of the ring saw main body (5).

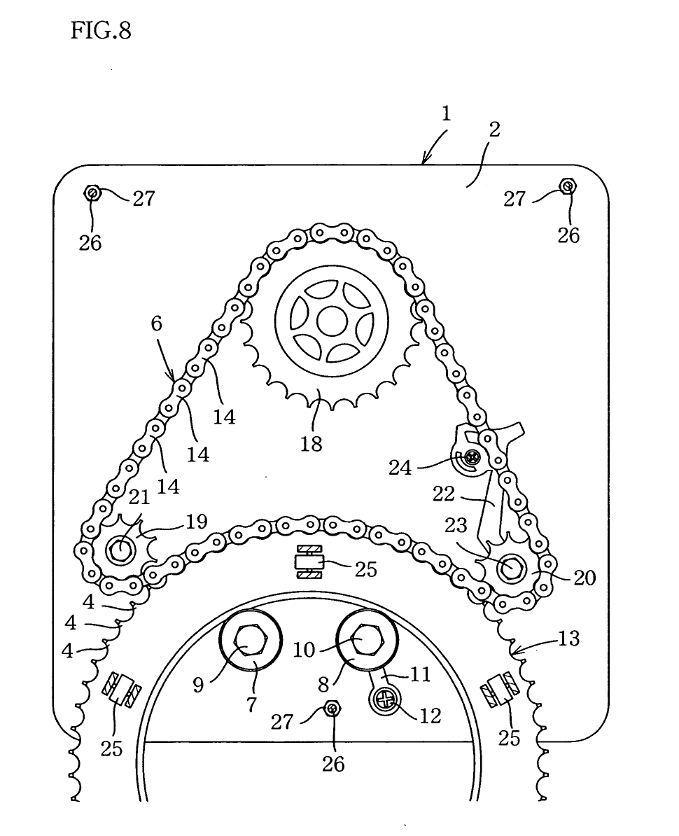

Furthermore, because this embodiment can change the position of the movable sprocket (50), tension can be adjusted over the endless chain (46) similarly to the first embodiment. Accordingly, in a replacement with the smaller diameter of a ring saw main body as shown in FIG. 8 for example, tension can be adjusted over the endless chain (46) such that the endless chain (46) is wound along the outer periphery of the ring saw main body (13) without causing a gap.

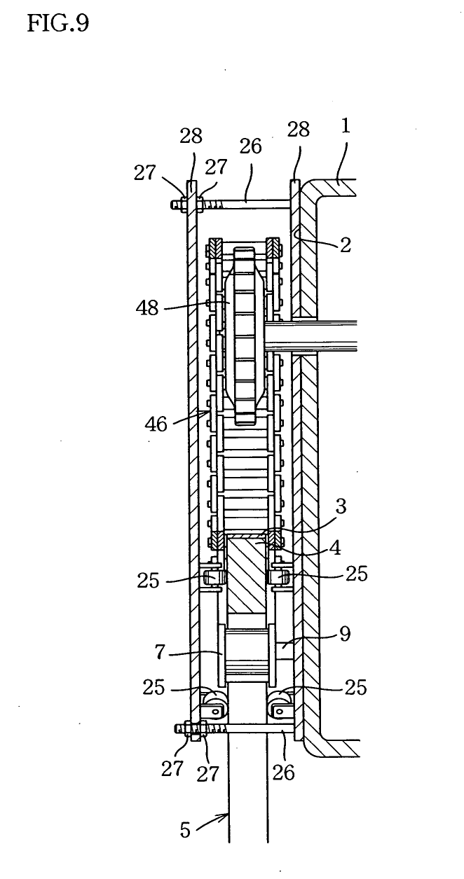

Meanwhile, as shown in FIG. 9, there are arranged a pair of side-surface guide rollers (25), (25) . . . as side-surface support members similarly to the first embodiment, on the both side surfaces of the ring saw main body (5), thus preventing the ring saw main body (5) from deviating vertically to the circulation plane thereof.

Furthermore, the driver in the second embodiment is adapted to be attached to a cutter device (30) similar to the first embodiment. In a certain case, it may be attached to a handy-type cutter device.

Incidentally, in the second embodiment, the other structure and effect is similar to the first embodiment. In the figure, the members having the same function to the first embodiment are attached with the same references.

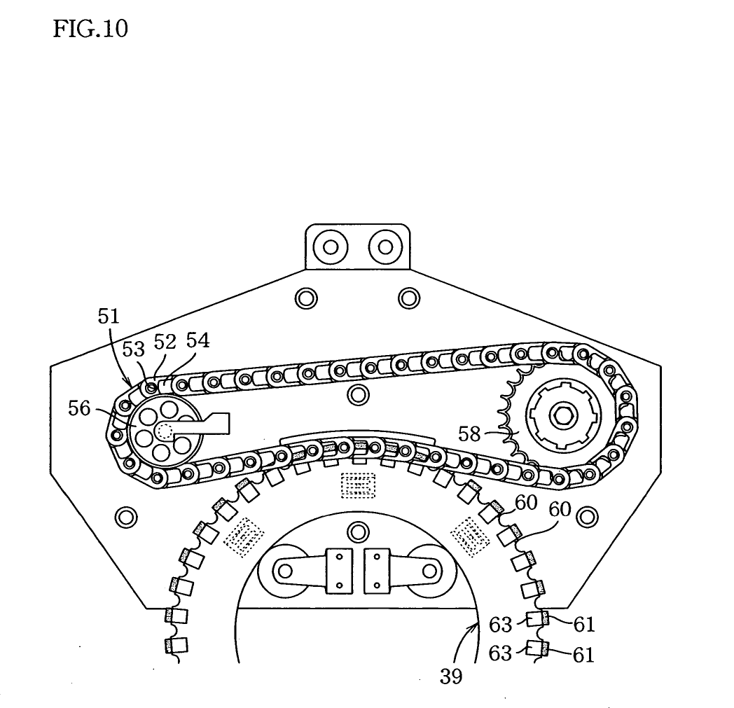

Explanation is made below on a ring saw driver according to a third embodiment of the invention, based on FIG. 10. In the figure, (51) is an endless chain for driving the ring saw main body (39) into circulation, which is a connection of a plurality of links (52), (52) . . . in an annular form by means of pins (53), (53). . . . Each link (52), (52) . . . is formed with openings (54), (54) . . . on the both side surfaces thereof.

The endless chain (51) is wound over between a driving sprocket (58) and a pulley (56). In this manner, by winding the endless chain (51) over the two rotary members, the driver can be reduced in the number of members and the driver can be light-weighted and made compact.

Incidentally, this embodiment uses the pulley (56) as a rotary member not for driving, a sprocket may be used similarly to the second embodiment shown in FIG. 6. Conversely, in the second embodiment, pulleys may be used as rotary members not for driving in place of the sprocket (49), (50).

Meanwhile, at least one rotary member of the driving sprocket (58) and the pulley (56) is arranged changeable in position along a plane including a circulation plane of the endless chain (51). By changing the position of the rotary member, tension can be adjusted over the endless chain (51).

Furthermore, in this embodiment, cutting edges (61), (61) . . . are formed integral with bases (63), (63) . . . removably attached on the teeth (60), (60) of the ring saw main body (39). These are made as chips in order for replacement together with the bases (63), (63)

Incidentally, in the third embodiment, an endless belt (6) similar to FIG. 1 may be used in place of the endless chain (51). In the case that an endless belt (6) is used in the third embodiment, pulleys are used in place of the sprocket (58) also on the driving rotary member besides the rotary member not for driving similarly to the first embodiment shown in FIG. 1.

Meanwhile, the mechanism for driving the driving sprocket (58), the structure for changing the position of any one or both of the driving sprocket (58) and the pulley (56), and the other structure and effect are similar to the first embodiment, hence omitting detailed explanation thereon.

The invention is not limited to the above embodiments. It is natural that the above embodiments can be modified and revised in many ways without the scope of the invention.

### INDUSTRIAL APPLICABILITY

As discussed above, the ring saw driver and cutter device according to the invention is useful as a device for cutting a hard material such as stone or concrete, particularly for use by being attached to a construction machine such as a backhoe.

1. A ring saw driver comprising:
a ring saw main body having a multiplicity of cutting edges along an outer periphery thereof; and
an endless strip arranged in a manner being wound at a part of an outer periphery thereof over a part of an outer periphery of the ring saw main body and for driving the ring saw main body into circulation.

2. A ring saw driver according to claim 1, wherein the endless strip is an endless belt.

3. A ring saw driver according to claim 2, wherein the endless belt has such a recess or a projection as to engage with a projection or a recess in the outer periphery of the ring saw main body.

4. A ring saw driver according to claim 2, wherein the endless belt has a through-hole for avoiding an interference of the ring saw main body with the cutting edge.

5. A ring saw driver according to claim 1, wherein the endless strip is an endless chain structured to engage with a plurality of teeth formed along the outer periphery of the ring saw main body, in a portion being wound over the outer periphery of the ring saw main body.

6. A ring saw driver according to claim 1, wherein the endless strip is wound over a plurality of rotary members, part of the rotary members being a driving sprocket or pulley operably coupled to a prime mover of a hydraulic motor or the like.

7. A ring saw driver according to claim 6, wherein the endless strip is wound over two rotary members, at least one of the rotary members being a driving sprocket or pulley.

8. A ring saw driver according to claim 1, wherein one or a plurality of inner support members supporting the ring saw main body at an inside thereof are provided on an inner peripheral side of the ring saw main body.

9. A ring saw driver according to claim 6, wherein part of or all the rotary members are to be changed in position along a plane including a circulation plane of the endless strip, the endless strip being to be adjusted in tension by changing a position of the rotary member.

10. A ring saw driver according to claim 8, wherein the ring saw main body is removably attached on the driver, part of or all the inner support members being to be changed in position along a circulation plane direction of the ring saw main body, a ring saw main body different in diameter being to be attached by changing a position of the inner support member or by changing a position of the inner support member and the rotary member.

11. A ring saw driver according to claim 1, wherein a pair of side-surface support members are arranged in a manner clamping the ring saw main body at both side surface thereof.

12. A ring saw driver according to claim 11, wherein the side-surface support member is a guide roller to roll-contact with a side surface of the ring saw main body due to circulation of the ring saw main body.

13. A ring saw-equipped cutter device to be removably fixed as an attachment to an arm tip of a shovel-based excavator such as a backhoe, the cutter device comprising:
a ring saw main body having a multiplicity of cutting edges along an outer periphery thereof, and
an endless strip arranged in a manner being wound at a part of an outer periphery thereof over a part of an outer periphery of the ring saw main body and for driving the ring saw main body into circulation.

14. A ring saw-equipped cutter device according to claim 13, wherein the endless strip is an endless belt.

15. A ring saw-equipped cutter device according to claim 14, wherein the endless belt has such a recess or a projection as to engage with a projection or a recess in the outer periphery of the ring saw main body.

16. A ring saw-equipped cutter device according to claim 13, wherein the endless strip is an endless chain structured to engage with a plurality of teeth formed along the outer periphery of the ring saw main body, in a portion being wound over the outer periphery of the ring saw main body.

17. A ring saw driver according to claim 3, wherein the endless belt has a through-hole for avoiding an interference of the ring saw main body with the cutting edge.

18. A ring saw driver according to claim 7, wherein part of or all the rotary members are to be changed in position along a plane including a circulation plane of the endless strip, the endless strip being to be adjusted in tension by changing a position of the rotary member.

19. A ring saw driver according to claim 8, wherein part of or all the rotary members are to be changed in position along a plane including a circulation plane of the endless strip, the endless strip being to be adjusted in tension by changing a position of the rotary member.

20. A ring saw driver according to claim 9, wherein the ring saw main body is removably attached on the driver, part of or all the inner support members being to be changed in position along a circulation plane direction of the ring saw main body, a ring saw main body different in diameter being to be attached by changing a position of the inner support member or by changing a position of the inner support member and the rotary member.
